(19) United States
(12) Patent Application Publication
(10) Pub. No.: US 2007/0087941 A1
(43) Pub. Date: Apr. 19, 2007

(54) Storable fracturing suspensions containing ultra lightweight proppants in xanthan based carriers and methods of using the same

(75) Inventor: Kay E. Cawiezel, Fulshear, TX (US)

Correspondence Address: JONES & SMITH, LLP, THE RIVIANA BUILDING, 2777 ALLEN PARKWAY, SUITE 800, HOUSTON, TX, 77019-2141, US

(73) Assignee: BJ SERVICES COMPANY

(21) Appl. No.: 11/253,534

(22) Filed: Oct. 19, 2005

(51) Int. Cl. C09K 8/60; C09K 8/80

(52) U.S. Cl. 507/204; 507/211; 507/213

(57) ABSTRACT

A storable suspension for the treatment of a subterranean formation contains an ultra lightweight (ULW) particulate and a carrier fluid of xanthan gum or a xanthan variant, a polysaccharide and water. The suspension exhibits a high viscosity at low shear rates and does not appear to separate for at least one week. The weight ratio of polysaccharide:xanthan in the storable suspension is between from about 8:1 to about 1:8. Prior to introducing the suspension into the formation, a foaming agent may be added, preferably in an amount sufficient to render a foam quality between from about 30 to about 98.

### FIELD OF THE INVENTION

This invention relates generally to methods and compositions useful for subterranean formation treatments, such as hydraulic fracturing treatments and sand control. In particular, this invention relates to use of storable suspensions comprising a carrier fluid of xanthan and a polysaccharide and ultra lightweight particles as proppant material for use in hydraulic fracturing treatments and as particulate material in sand control methods such as gravel packing, frac pack treatments, etc.

### BACKGROUND OF THE INVENTION

Hydraulic fracturing is a common stimulation technique used to enhance production of fluids from subterranean formations. In a typical hydraulic fracturing treatment, fracturing treatment fluid of a solid proppant and gelled carrier fluid is injected into the wellbore at high pressures. Once natural reservoir pressures are exceeded, the fluid induces fractures in the formation and proppant is deposited in the fracture, where it remains after the treatment is completed. The proppant material serves to hold the fracture open, thereby enhancing the ability of fluids to migrate from the formation to the wellbore through the fracture.

Formulation of gelled carrier fluids usually requires specifically designed equipment and mixing stages. At the time of proppant addition, the carrier fluid typically exhibits poor solid suspending properties and vigorous agitation is often required to prevent gravity segregation of the solids. In conventional systems, the carrier fluid is delivered either from one or more pre-gelled tanks or customized hydration units. Buffers, breakers, surfactants and other additives which may be required during treatment are typically metered into the fluid “on-the-fly”. The proppant is then delivered from one or more storage bins or silos by gravity and added to the fluid by way of conveyors or augers. The operation of combining the proppant with the fluid typically involves the use of a slurry blender, a relatively sophisticated and costly piece of equipment. The slurry blender homogenizes the mix of proppant and carrier fluid and allows the addition of viscosifying enhancing agents, thus improving proppant transport. Further, it feeds at least one high pressure pump which are used to inject the proppant slurry into the wellhead. The need to “ramp” or step-up the concentration of proppant, as the operation proceeds, requires considerable operator expertise and/or requires the use of an array of process control equipment to enable accurate proportioning of all the components at various rates. Any operational failure, such as tub overflow, improper amount of viscosity enhancer, breaker, etc., jeopardizes the operation or its results.

Attempts have been made with conventional proppants to obtain pumpable formulations for use on the fly. Unfortunately, such formulations require a high degree of fluid gellation to maintain suspension of the heavy particles. Even with heavy gellation, such suspensions are further subject to particle settling within a matter of hours, particularly in the presence of vibration. Note, for instance, the settling rates set forth in U.S. Pat. No. 5,591,699. Such settling rates necessitate well defined mixing capabilities in order to homogeneously re-suspend the proppants in high viscosity suspension gels on-site. Significant costs are further incurred for the chemicals, equipment and processing time in order to gel the carrier fluid. Pumpable suspensions which do not exhibit particle settling have therefore been sought.

### SUMMARY OF THE INVENTION

The storable suspension of the invention contains an ultra lightweight (ULW) particulate and a carrier fluid comprising a xanthan gum or variant thereof, a polysaccharide and water. The suspension exhibits high viscosity at low shear rates, e.g., a viscosity at 0.1 sec⁻¹ has been displayed between from about 4,000 to about 30,000 cP. The suspension does not separate for at least one week. The ULW particulate has an apparent specific gravity less than or equal to 2.45. The suspension is of use in hydraulic fracturing applications, or in other well treating applications such as sand control.

The xanthan may be an unmodified xanthan gum, non-acetylated xanthan gum, non-pyruvylated xanthan gum or non-acetylated-non-pyruvylated xanthan gum. The polysaccharide is preferably selected from the group consisting of guar, carrageenan, gum Arabic, gum ghatti, karaya, tragacanth, pectin, starch, locust bean gum, scleroglucan, tamarind and derivatives thereof. The weight ratio of polysaccharide:xanthan in the storable suspension is between from about 8:1 to about 1:8.

Prior to introducing the suspension into the formation, a foaming agent may be added, preferably in an amount sufficient to render a foam quality between from about 30 to about 98.

### BRIEF DESCRIPTION OF THE DRAWINGS

FIG. 1 illustrates the rheological characteristics of the carrier fluid used in the invention and demonstrates the synergistic effect displayed by the combination of xanthan and guar gum.

FIG. 2 illustrates the increased viscosity at low shear versus high shear of the fluid of the invention.

FIG. 3 illustrates the rheology of the foamed fluid of the invention.

### DETAILED DESCRIPTION OF THE PREFERRED EMBODIMENTS

The storable suspension of the invention contains, as carrier fluid, a thickened (uncrosslinked) linear gel having at least one xanthan gum or xanthan gum variant and a polysaccharide. The combination of xanthan and polysaccharide renders high viscosity at low shear to the carrier fluid. Thus, ultra lightweight particulates may be suspended in the carrier fluid for extended periods of time. The fluid of the carrier fluid is typically brine, salt water, fresh water or a liquid hydrocarbon; preferably tap water.

The viscosity of a 25 pound per 1,000 gallon suspension in accordance with the invention is approximately between from about 40 to about 75, preferably bout 50, cP at 100 sec⁻¹ at 75° F. In contrast, the viscosity of the suspension at low shear, for instance around 0.1 sec⁻¹, at 75° F. is between from about 4,000 to about 30,000 cP.

Xanthan gums or variants suitable for use in the invention include conventional (unmodified) xanthan gums as well as non-acetylated xanthan gums (NAX), non-pyruvylated xanthan gums (NPX) and non-pyruvylated non-acetylated xanthan gums (NPNAX). The non-pyruvylated xanthan gums include those xanthenes with and without acetate substituents. Preferred are conventional xanthan and non-acetylated xanthan gums.

Suitable xanthan gums include such conventional xanthan gums as native xanthan gums, like those described in U.S. Pat. Nos. 3,020,206, 3,020,207, 3,391,060 and 4,154,654, all of which are herein incorporated by reference.

It is preferred to use xanthan gums produced by the bacterium Xanthomonas campestris, as set forth in U.S. Pat. No. 3,659,026 (herein incorporated by reference), though other Xanthomonas bacteria may be used, such as Xanthomonas carotate, Xanthomonas incanae, Xanthomonas begoniae, Xanthomonas malverum, Xanthomonas vesicatoria, Xanthomonas papavericola, Xanthomonas translucens, Xanthomonas vasculorum and Xanthomonas hederae.

Xanthan gum is a hydrophilic heteropolysaccharide of high molecular weight, composed of D-glucose, D-mannose and D-glucuronate moieties in a molar ratio of 2:2:1, respectively. Conventional xanthan gum is typically acetylated and pyruvylated to various degrees. Acetate substituents are found on xanthan gum in two different locations. One is located through an ester linkage at the C6 position of the mannose residue adjacent to the main chain. Another acetate substituent may be found on the terminal mannose residue of the side chain in situations where this mannose residue is not pyruvylated. The second acetyl substituent is typically found at very low levels in conventional xanthan gum.

The term “non-pyruvylated xanthan gum”, as used in the present context, includes a xanthan gum having a pyruvate content of about 0 to about 1.5%, preferably of about 0 to about 1.0%, and more preferably, of about 0 to about 0.5%. The term “non-acetylated xanthan gum”, as used in the present context, includes a xanthan gum having an acetate content of about 0 to about 1.5%, preferably of about 0 to about 1.0%, and more preferably of about 0 to about 0.5%. The term “non-pyruvylated-non-acetylated xanthan gum”, as used in the present context, includes a xanthan gum having a pyruvate content of about 0 to about 1.5% and an acetate content of about 0 to about 1.5%, preferably a pyruvate content of about 0 to about 1.0% and an acetate content of about 0 to about 1.0%, and more preferably, a pyruvate content of about 0 to about 0.5% and an acetate content of about 0 to about 0.5%.

Non-acetylated and/or non-pyruvylated xanthan gum for use in this invention may be prepared by chemical deacetylation of xanthan gum. See, for instance, the chemical deacetylation of xanthan gum set forth in U.S. Pat. Nos. 3,000,790 and 3,054,689, herein incorporated by reference. Alternative methods of generating deacylated xanthan gum are well-known to those of skill in the art. Suitable non-pyruvylated xanthan gums and non-pyruvylated non-acetylated xanthan gums further include those set forth in U.S. Pat. No. 6,573,221, herein incorporated by reference.

The xanthan gum variants for use in this invention may further be genetically prepared, such as by fermentation of mutant strains of Xanthomonas campestris as described in U.S. Pat. Nos. 4,296,203 and 5,514,791, herein incorporated by reference.

Polysaccharides suitable for use in the invention include such hydrophilic polymers as natural gums (exclusive of xanthan) like guar, carrageenan, gum Arabic, gum ghatti, karaya, tragacanth, pectin, starch, locust bean gum, scleroglucan, tamarind and any chemically modified derivatives of these gums including derivatives of cellulose such as the pendent derivatives hydroxyethyl, hydroxypropyl, hydroxypropylcarboxymethyl, hydroxyethylcarboxymethyl, carboxymethyl or methyl. Specific examples of polysaccharides useful in the present invention include but are not limited to guar gum, hydroxypropyl guar, carboxymethyl guar, carboxymethyl hydroxypropyl guar, carboxymethyl hydroxypropyl guar and known derivatives of these gums. The polymers, like the xanthan gums, may be used as their slurry counterparts.

The weight ratio of polysaccharide:xanthan is typically from about 8:1 to about 1:8, preferably from about 4:1 to 1:1, most preferably about 4:1.

Typically, the polysaccharide and xanthan are added to water simultaneously. Addition of these components to water immediately commences gelation. The polysaccharide and xanthan may also be premixed and then added to the water. The amount of polysaccharide and xanthan in the storable suspension is between from about 10 to about 60 pounds per thousand gallons.

The carrier fluid is used to support an ultra lightweight particulate having an apparent specific gravity (ASG) less than or equal to 2.45. Generally, the ASG of the ULW particulate is less than or equal to 2.25, more preferably less than or equal to 2.0, even more preferably less than or equal to 1.75, most preferably less than or equal to 1.25.

Suitable ULW particulates include those set forth in U.S. Patent Publication No. 20050028979, published on Feb. 10, 2005, herein incorporated by reference.

Included therein are naturally occurring materials which may be strengthened or hardened by use of modifying agents to increase the ability of the naturally occurring material to resist deformation. Specific examples of such molecules include, but are not limited to, polysaccharides found in plants that serve to enhance strength of plant materials including, but not limited to, polysaccharides containing Beta (1-4) linked sugars. Specific examples include, but are not limited to, cellulose, mannans, natural resins and ligands, specific substances such as polyphenolic esters of glucosides found in tannin from walnut hulls, etc.

Specific examples of ULW particulates include, but are not limited to, ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc., including such woods that have been processed by grinding, chipping, or other form of particalization, processing, etc.

Further suitable particulates include porous ceramics or organic polymeric particulates. The porous particulate material may be treated with a non-porous penetrating material, coating layer or glazing layer. For instance, the porous particulate material may be a treated particulate material, as defined in U.S. Patent Publication No. 20050028979 wherein (a) the ASG of the treated porous material is less than the ASG of the porous particulate material; (b) the permeability of the treated material is less than the permeability of the porous particulate material; or (c) the porosity of the treated material is less than the porosity of the porous particulate material. In a preferred embodiment, the penetrating material and/or coating layer and/or glazing layer of the selectively configured porous particulate material is capable of trapping or encapsulating a fluid having an ASG less than the ASG of the carrier fluid. Further, the coating layer and/or penetrating material and/or glazing material may be a liquid having an ASG less than the ASG of the matrix of the porous particulate material.

Further, the ultra lightweight particulate may be a well treating aggregate composed of an organic lightweight material and a weight modifying agent. The ASG of the organic lightweight material is either greater than or less than the ASG of the well treating aggregate depending on if the weight modifying agent is a weighting agent or weight reducing agent, respectively. Where the weight modifying agent is a weighting agent, the ASG of the well treating aggregate is at least one and a half times the ASG of the organic lightweight material, the ASG of the well treating aggregate preferably being at least about 1.0, preferably at least about 1.25. In a preferred embodiment, the ASG of the organic lightweight material in such systems is approximately 0.7 and the ASG of the well treating aggregate is between from about 1.05 to about 1.20. Where the weight modifying agent is a weight reducing agent, the ASG of the weight reducing agent is less than 1.0 and the ASG of the organic lightweight material is less than or equal to 1.1. In a preferred mode, the organic lightweight material forms the continuous (external) phase for the well treating aggregate, whereas the weight modifying agent forms the discontinuous (internal) phase. The weight modifying agent may be sand, glass, hematite, silica, sand, fly ash, aluminosilicate, and an alkali metal salt or trimanganese tetraoxide. Further, the weight modifying agent may be a cation selected from alkali metal, alkaline earth metal, ammonium, manganese, and zinc and an anion selected from a halide, oxide, a carbonate, nitrate, sulfate, acetate and formate. Glass bubbles and fly ash are preferred when the weight modifying agent is a weight reducing agent. The organic lightweight material is preferably a thermosetting resin.

When introduced or pumped into a well, the particulate of the storable suspension may be neutrally buoyant in the carrier fluid, eliminating the need for damaging polymer or fluid loss material.

The ULW particulate is mixed at its desired concentration with the carrier fluid. The amount of ULW particulate typically added to the linear gel carrier fluid is typically between from about 0.5 to about 8.0, preferably between from about 1 to about 4.0, pounds of particulate per gallon of linear gel.

It may be desirable to weight the carrier fluid by the addition of a salt, such as sodium chloride, potassium chloride, etc. This increases the density of the linear gels; the higher density also helps to support the particulate during storage.

The ASG of the ultra lightweight particulate is preferably the same as, but typically no greater than 0.25 higher than, the ASG of the carrier fluid; preferably the ASG of the ultra lightweight particulate is no greater than 0.20 higher than the ASG of the carrier fluid. For example, LiteProp™ 125 lightweight proppant, a product of BJ Services Company, having an ASG of 1.25 is neutrally buoyant in a 10.4 lb/gal (ppg) brine and is easily suspended in such brine. A brine lower in ASG than the particulate and having slight viscosity could be employed.

The carrier fluid may further contain a complexing agent, gel breaker, surfactant, biocide, surface tension reducing agent, scale inhibitor, gas hydrate inhibitor, polymer specific enzyme breaker, oxidative breaker, buffer, clay stabilizer, acid or a mixture thereof and other well treatment additives known in the art. The addition of such additives to the carrier fluids minimizes the need for additional pumps required to add such materials on the fly.

Choice of different materials and amounts thereof to employ in such blends may be made based on one or more well treatment considerations including, but not limited to, objectives for creation of propped fractures, well treatment fluid characteristics, such as ASG and/or rheology of carrier fluid, well and formation conditions such as depth of formation, formation porosity/permeability, formation closure stress, type of optimization desired for geometry of downhole-placed particulates such as optimized fracture pack propped length, optimized fracture pack and combinations thereof.

It is often preferred to add a conventional complexing agent, such as EDTA or nitriloacetic acid to complex calcium ions, thereby permitting the xanthan to disperse and hydrate.

The storable suspension of the invention exhibits little, if any, tendency to settle over prolonged periods of time. For instance, no settling may be noted for at least three days, typically greater seven days or more.

The storable suspension may be pumped or placed downhole as is or diluted on the fly. The storable suspension may be diluted to a lower concentration depending on the design and operating parameters of the targeted job.

Further, a foaming agent may be added, with a gas or gaseous liquid such as air, nitrogen or carbon dioxide, to the fluid on the fly without the need of a blender. When employed, such foaming agents are capable of rendering a foam quality between from about 30 to about 98 (30/70 to 98/2 weight percent gas/gaseous liquid:fluid), preferably 95, foam. The use of a foaming agent is especially desirable in the treatment of substantially depleted reservoirs since the amount of xanthan and polysaccharide introduced into the formation may be dramatically minimized.

The improved foaming properties may be attributable to the low concentration of xanthan relative to the polysaccharide in the carrier.

The foaming agent is preferably an anionic surfactant. Most preferred are alpha-olefin sulfonates and/or alkyl ether sulfates. Preferred as alpha-olefin sulfonates are salts of a monovalent cation such as an alkali metal ion like sodium, lithium or potassium, an ammonium ion or an alkyl-substituent or hydroxyalkyl substitute ammonium in which the alkyl substituents may contain from 1 to 3 carbon atoms in each substituent. The alpha-olefin moiety typically has from 12 to 16 carbon atoms. Preferred alkyl ether sulfates are also salts of the monovalent cations referenced above. The alkyl ether sulfate may be an alkylpolyether sulfate and contains from 8 to 16 carbon atoms in the alkyl ether moiety. Preferred as anionic surfactants are sodium lauryl ether sulfate (2-3 moles ethylene oxide), C₈-C₁₀ ammonium ether sulfate (2-3 moles ethylene oxide) and a C₁₄-C₁₆ sodium alpha-olefin sulfonate and mixtures thereof. Especially preferred are ammonium ether sulfates.

The use of the fluid in accordance with the invention eliminates the need for a blender on location; the simpler configuration of metering valves and pumps allowing the pumpable slurry to be diluted in-line to the desired concentration. A further benefit is the improved control of concentrations of particulates, especially since liquids are more accurately metered than solids.

The elimination of equipment on location has several economic advantages in that it saves on equipment costs and, in areas where job location space is at a premium, such as at mountainside locations, wells that were previously incapable of being stimulated become realistic targets. Further, the suspension of the invention provides the opportunity to pump the slurry concentrate from a transport located some distance from the well location versus conventional systems which require particulate transport near the blender and wellhead.

Further, the use of the fluid of the invention eliminates the need for a slurry blender, as well as fluid hydration unit, on location since a simple configuration of metering valves and a pump would allow the neat slurry to be diluted in-line with water to the desired concentration.

The storable suspensions of the invention may be used in a sand control method for a wellbore penetrating a subterranean formation and may be introduced into the wellbore in a slurry to form a fluid-permeable pack that is capable of reducing or substantially preventing the passage of formation particles from the subterranean formation into the wellbore while at the same time allowing passage of formation fluids from the subterranean formation into the wellbore.

When used in hydraulic fracturing, the suspension may be injected into a subterranean formation in conjunction with other treatments at pressures sufficiently high enough to cause the formation or enlargement of fractures or to otherwise expose the proppant material to formation closure stress. Such other treatments may be near wellbore in nature (affecting near wellbore regions) and may be directed toward improving wellbore productivity and/or controlling the production of fracture proppant or formation sand. Particular examples include gravel packing and frac-packs. Moreover, such aggregates may be employed alone as a fracture proppant/sand control particulate, or in mixtures in amounts and with types of fracture proppant/sand control materials, such as conventional fracture or sand control particulate.

In one exemplary embodiment, a gravel pack operation may be carried out on a wellbore that penetrates a subterranean formation to prevent or substantially reduce the production of formation particles into the wellbore from the formation during production of formation fluids. The subterranean formation may be completed so as to be in communication with the interior of the wellbore by any suitable method known in the art, for example by perforations in a cased wellbore, and/or by an open hole section. A screen assembly such as is known in the art may be placed or otherwise disposed within the wellbore so that at least a portion of the screen assembly is disposed adjacent the subterranean formation. A slurry including the ULW particulates and carrier fluid may then be introduced into the wellbore and placed adjacent the subterranean formation by circulation or other suitable method so as to form a fluid-permeable pack in an annular area between the exterior of the screen and the interior of the wellbore that is capable of reducing or substantially preventing the passage of formation particles from the subterranean formation into the wellbore during production of fluids from the formation, while at the same time allowing passage of formation fluids from the subterranean formation through the screen into the wellbore.

As an alternative to use of a screen, the sand control method may use the ULW particulates in accordance with any method in which a pack of particulate material is formed within a wellbore that it is permeable to fluids produced from a wellbore, such as oil, gas, or water, but that substantially prevents or reduces production of formation materials, such as formation sand, from the formation into the wellbore. Such methods may or may not employ a gravel pack screen, may be introduced into a wellbore at pressures below, at or above the fracturing pressure of the formation, such as frac pack, and/or may be employed in conjunction with resins such as sand consolidation resins if so desired.

The following examples will illustrate the practice of the present invention in its preferred embodiments. Other embodiments within the scope of the claims herein will be apparent to one skilled in the art from consideration of the specification and practice of the invention as disclosed herein. It is intended that the specification, together with the example, be considered exemplary only, with the scope and spirit of the invention being indicated by the claims which follow. All parts are given in terms of weight units except as may otherwise be indicated.

### EXAMPLES

DFG Xanthan refers to unmodified xanthan gum, commercially available as KELZAN XC from Kelco Oil Field Group, Inc.;

NA Xanthan refers to non-acetylated xanthan;

NTA refers to nitrolacetic acid, a complexing agent;

LiteProp™ 125 refers to an ultra lightweight proppant, a product of BJ Services Company, having an ASG of 1.25; and

FAW 20 refers to ammonium ether sulfate surfactant, a product available from BJ Services Company.

### Examples 1-6

Guar and xanthan were introduced to 500 ml. tap water, optionally having NTA, at room temperature and the system was blended for 30 minutes. Comparative systems were prepared were prepared using guar and the xanthan by themselves. The components of each example are set forth in Table I below.

TABLE I

| Example No. | NA Xanthan, g | Guar, g | DFG Xanthan, g | NTA, ml |
|---|---|---|---|---|
| 1 | 0.3 | 1.2 | — | 1.5 |
| 2 | — | 1.2 | 0.3 | 1.5 |
| Comp. Ex. 3 | — | 1.2 | — | — |
| Comp. Ex. 4 | 0.3 | — | — | 1.5 |
| Comp. Ex. 5 | — | — | 0.3 | 1.5 |

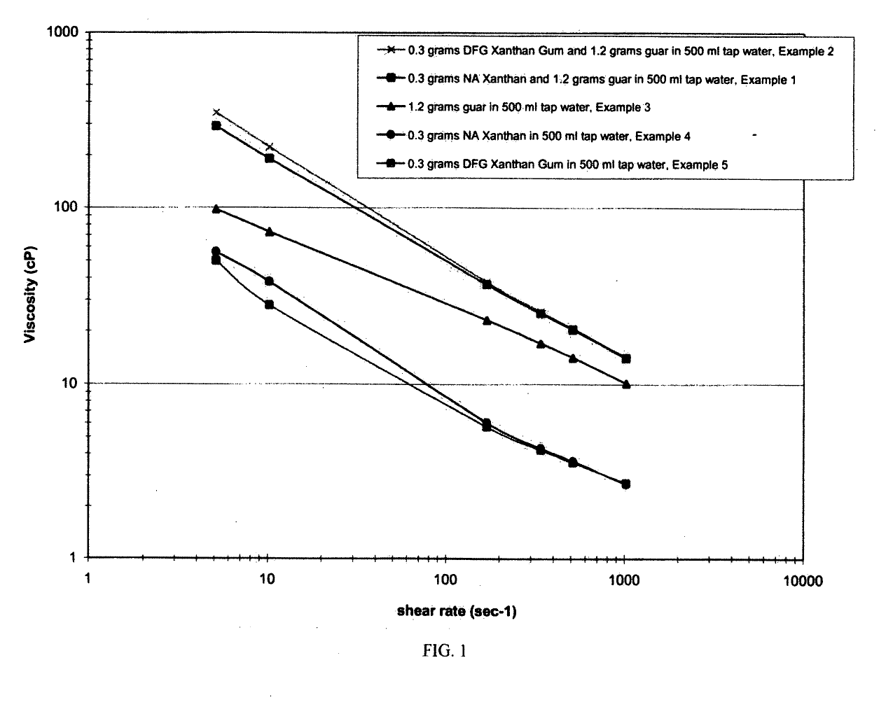

Low shear viscosity data was obtained using a Grace 3500LS viscometer, a non-pressurized concentric cylinder viscometer equipped with a 1.0 spring and a R1-B1 geometry, having a speed between from 0.06 to 600 rpm, enabling measurements from 0.1 to 1020 sec⁻¹ at 75° F. The data is set forth in FIG. 1. FIG. 1 illustrates the synergistic effect evidenced by the blend of xanthan and guar. For example, Comp. Examples 3 and 4 illustrate a viscosity of approximately 23 and 6 cP, respectively, at a shear rate of 170 sec⁻¹ 75° F. whereas Example 1 illustrates a viscosity of 35 cP at 75° F.

### Example 7

0.3 g of NA Xanthan and 1.2 g of guar were introduced to 500 ml of water and blended at room temperature for about 30 minutes. 72 g KCl was then mixed thereto for about 30 minutes. About 274 g of LiteProp™ 125 was then added to the suspension and the suspension was then mixed until homogeneous. The fluid was then transferred into a 500 ml graduated cylinder and was permitted to set for seven days. The percent settling was measured daily. As set forth in Table II below, the suspension evidenced little, if any, settling after being stored for one week at room temperature.

TABLE II

| Time, days | Percent settling, 75° F. |
|---|---|
| 1 | 0 |
| 2 | 0 |
| 3 | 0 |
| 4 | 0 |
| 5 | 0 |
| 6 | 2 |
| 7 | 5 |

### Example 8

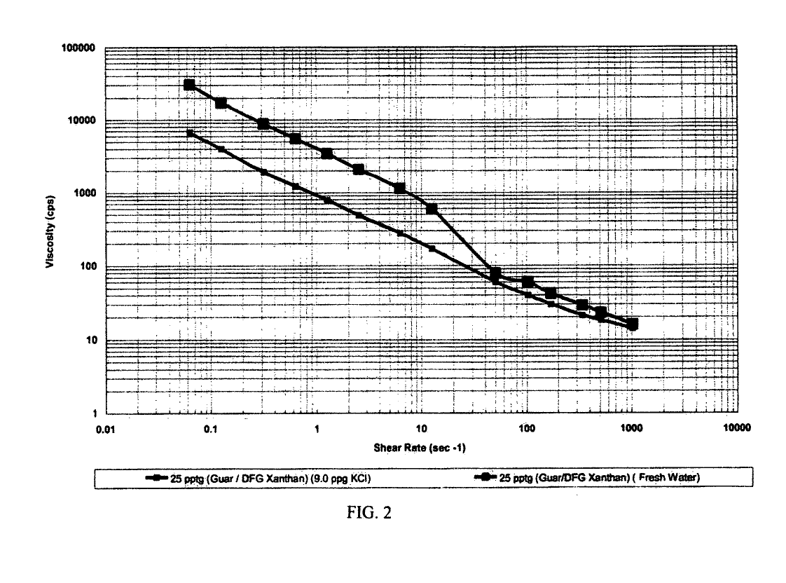

Two samples were prepared by introducing 0.3 g of DFG Xanthan and 1.2 g of guar to 500 ml. fresh water and allowing mixing to occur for about 30 minutes at room temperature. To one of the samples was then added 72 g of KCI and mixing was allowed to occur for an additional 30 minutes at room temperature. Low shear viscosity data was obtained using a Brookfield DV-II viscometer, a non-pressurized concentric cylinder viscometer equipped with a #3 spindle with speed ranges from 0.05 to 10 rpm enabling measurements from 0.063 to 12.6 sec-1 at 75° F. FIG. 2 which combines the Brookfield and Grace Viscometer viscosity data demonstrates the low shear viscosity of the carrier fluid with and without salt.

### Example 9

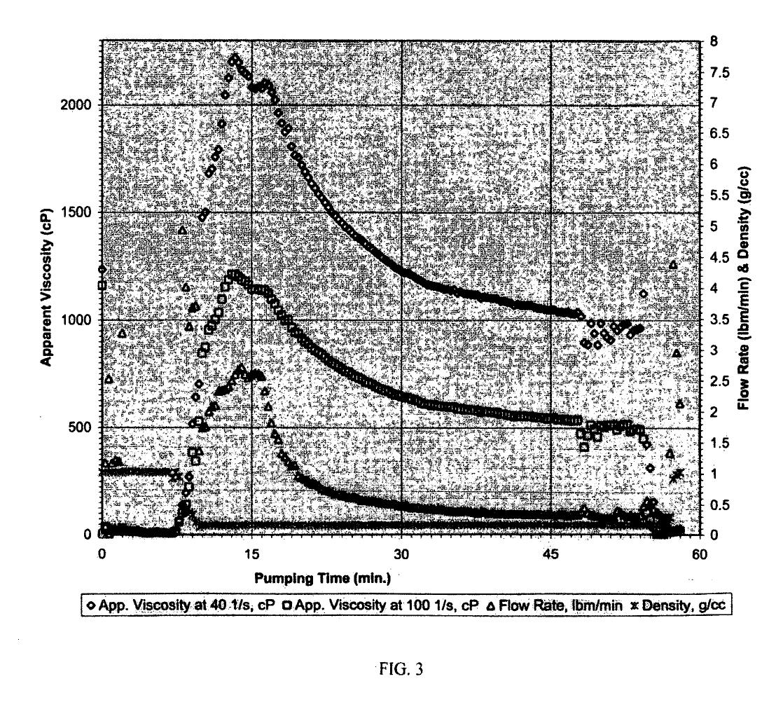

0.1 lbs of DFG Xanthan, 0.4 lbs. of guar and 0.04 gallons of NTA were added to 20 gallons of water and mixing was allowed to proceed for 30 minutes at 100° F. 23 lbs. of KCl was then added and mixing was allowed to occur for an additional 30 minutes at 100° F. A 95 quality stable foam was then prepared by adding to the resulting suspension about 0.3 gallons of FAW-20 surfactant followed by the addition of nitrogen. The suspension was then stirred for an additional 30 minutes. FIG. 3 demonstrates the increased viscosity at low shear, 40 sec⁻¹, versus higher shear, 100 sec⁻¹.

From the foregoing, it will be observed that numerous variations and modifications may be effected without departing from the true spirit and scope of the novel concepts of the invention.

What is claimed is:

1. A storable suspension comprising:
(i) xanthan gum or a xanthan variant;
(ii) a polysaccharide selected from the group consisting of hydrophilic polymers and natural gums (exclusive of xanthan).
(iii) an ultra lightweight (ULW) particulate having an apparent specific gravity less than or equal to 2.45; and
(iv) water.

2. The storable suspension of claim 1, wherein the suspension does not exhibit settling for at least three days.

3. The storable suspension of claim 2, wherein the suspension exhibits less than 10% settling after seven days.

4. The storable suspension of claim 1, wherein the viscosity of the carrier fluid at 0.1 sec⁻¹ is between from about 4,000 to about 30,000 cP.

5. The storable suspension of claim 1, wherein the xanthan is an unmodified xanthan gum.

6. The storable suspension of claim 1, wherein the polysaccharide is selected from the group consisting of like guar, carrageenan, gum Arabic, gum ghatti, karaya, tragacanth, pectin, starch, locust bean gum, scleroglucan, tamarind and derivatives thereof.

7. The storable suspension of claim 6, wherein the polysaccharide is selected from the group consisting of guar gum, hydroxypropyl guar, carboxymethyl guar, carboxymethyl hydroxypropyl guar, carboxymethyl hydroxypropyl guar.

8. The storable suspension of claim 1, wherein the weight ratio of polysaccharide:xanthan is from about 8:1 to about 1:8.

9. The storable suspension of claim 8, wherein the weight ratio of polysaccharide:xanthan is from about 4:1 to about 1:1.

10. The storable suspension of claim 1, wherein the xanthan variant is selected from the group consisting of non-acetylated xanthan gum, non-pyruvylated xanthan gum and non-acetylated-non-pyruvylated xanthan gum.

11. The storable suspension of claim 1, wherein the ULW particulate has an apparent specific gravity less than or equal to 1.75.

12. The storable suspension of claim 11, wherein the ULW particulate has an apparent specific gravity less than 1.25.

13. The storable suspension of claim 1, wherein the ULW particulate is at least one particulate selected from the group consisting of ground or crushed nut shells, ground or crushed seed shells, ground or crushed fruit pits, processed wood, or a mixture thereof, optionally at least partially surrounded by at least one layer of a protective or hardening coating.

14. The storable suspension of claim 1, wherein the ULW particulate is at least one particulate selected from the group consisting of porous ceramics, organic polymeric materials and well treating aggregates, optionally treated with a non-porous penetrating, coating and/or glazing material.

15. The storable suspension of claim 1, further comprising a complexing agent.

16. The storable suspension of claim 1, wherein the particulate is a proppant.

16. A method of treating a hydrocarbon-bearing subterranean formation which comprises
(A) formulating the storable suspension of claim 1;
(B) storing the storable suspension until required for treatment of the subterranean formation; and
(C) pumping the suspension into the subterranean formation.

17. The method of claim 16, wherein, prior to step (C), the storable suspension is diluted with water.

18. The method of claim 16, wherein, prior to step (C), adding to the suspension a foaming agent and a gas or gaseous liquid.

19. The method of claim 18, wherein the foaming agent is added to the suspension in an amount sufficient to render a foam quality between from about 30 to about 98.

20. The method of claim 18, wherein the foaming agent is an anionic surfactant selected from the group consisting of alpha-olefin sulfonates and alkyl ether sulfates or an ammonium salt thereof.

21. The method of claim 20, wherein the anionic surfactant is an alkylpolyether sulfate contains between from about 8 to about 16 carbon atoms in the alkyl ether moiety.

22. The method of claim 20, wherein the anionic surfactant is an ammonium ether sulfate.

23. A method of hydraulically fracturing a hydrocarbon-bearing subterranean formation which comprises
(A) formulating the storable suspension of claim 1 by adding the xanthan gum or xanthan gum variant and polysaccharide to the water to create a suspension and introducing the ultra lightweight particulate as proppant to the suspension;
(B) storing the storable fracturing suspension until required for fracturing; and
(C) pumping the fracturing suspension into the subterranean formation.
